(19) United States
(12) Patent Application Publication
(10) Pub. No.: US 2012/0262297 A1
(43) Pub. Date: Oct. 18, 2012

(54) SYSTEMS AND METHODS FOR MEASURING THE SKIING CONDITION FOR SKIERS

(76) Inventor: TAI CHEUNG POON, Hong Kong (HK)

(21) Appl. No.: 13/088,367

(22) Filed: Apr. 17, 2011

(51) Int. Cl. G08B 19/02

(52) U.S. Cl. 340/584

(57) ABSTRACT

Methods and systems for measuring the skiing condition for skiers. One embodiment of the invention includes using a goggle, a ski jacket, a ski, and a ski pole to set the skiing condition, measure the skiing condition, record the dangerous skiing condition, and share the skiing condition in real-time to other members. Additionally, the embodiment includes preparing for skiing in extreme conditions, such as icy condition, snow storms affecting visibility, and poor field conditions that impair accessibility of skiers. In addition, when these extreme conditions are detected, a mechanism to indicate the possibility has occurred is provided.

### FIELD OF THE INVENTION

This invention generally relates to measuring the skiing condition for skiers based on skiing equipments, including goggles, ski jackets, skis, and ski poles. Specifically, the invention relates to setting skiing conditions, measuring skiing conditions, recording the dangerous skiing conditions, and sharing skiing conditions in real-time to other members.

### BACKGROUND OF THE INVENTION

Skiing in the winter is a favorite sports to many people in the world. To many, skiing usually takes place in snowy mountains. These places are usually known as ski resorts, which provide facilities for skiing. The organizers of these resorts take good care the field condition, ensuring the snow condition is decent for skiing. If the amount of snow is less than necessary, the resort organizers may plow snow to ensure softness in the snow. When the amount of snow is getting further lower than adequate, the organizer may close certain ski trails to prevent skiers from skiing in those conditions.

For many skiers, however, skiing is not limited in ski resorts. Ski lovers sometimes like to ski in rural areas. In these places, unlike in ski resorts, the ski trails are not taken care of in advance. The most enjoyable part of skiing in rural areas is unpredictability. However, skiing in these areas is certainly less predictable, but at the same time, it can be dangerous. When one skies in a remote mountainous area, there are no dedicated professionals or staffs who can help monitoring the safety of the skier. When an accident occur, there is no immediate that can be made available. Safety under these conditions can become an alarming issue.

Safety of skiing can be dangerous because skiing is a sport that is not limited just to adults or professional skiers. Skiing is also a favorite sports to young children. Some of them learn to ski at very young ages, because that is the best time to master a sport like skiing. What becomes more dangerous is the sudden change of weather or skiing conditions, especially in these remote areas. In such cases, one key factor to determine if a skier is skiing under a safe condition is whether the skier is properly equipped. If the ski equipments are not properly prepared in dealing with the sudden change of condition, would the skier be able to make a safe return by himself or herself? For example, some ski poles and skis are made for downhill skiing, whereas others are made specifically for cross country skiing. As another example, clothing made of material that can suit for skiing in milder weather. When temperature drops to a certain degree, the material may not be able to keep warm for the skier.

In view of the foregoing, methods and systems are desired to detect when extreme conditions skiing occurs, in view of certain factors of the skier, including equipments, age, and skills of the skier. Also, a mechanism to report such conditions is necessary for skiing safely across all ages and all skill levels.

### SUMMARY OF THE INVENTION

A system is provided to ensure safety of a skier. In one embodiment, a system includes a ski pole, wherein the pole is associated with a type that belongs to a cross country ski pole or a alpine ski pole. The system includes a rf antenna coupled to the ski pole, identifying the type of the ski pole; a ski, wherein the pole is associated with a type that belongs to a cross country ski or a alpine ski.

The exemplary system includes a rf antenna coupled to the ski, identifying the type of the ski; a speed detecting device included in the ski to detect a speed and an acceleration of the ski; an accelerometer device included in the ski configured to detect inclination of slope where the skier is skiing, and detect any icy conditions of current location, based on orientation detected by the accelerometer and the speed and acceleration detected by the speed detecting device.

The system further may include a piece of clothing, wherein the clothing is associated with a material associating with a temperature, the temperature representing a lowest temperature endured by the skier wearing the clothing; a rf antenna coupled to the clothing, identifying the type of the clothing.

A goggle may optionally included, comprising a temperature processor that includes a temperature reader in the goggle detects current temperature and determines if the current temperature is below the lowest temperature endured by the skier; a rf reader included in the goggle synchronized with the antennas of the ski pole, ski, and clothing, wherein the rf reader receives information from the ski pole, ski, and clothing; a rf antenna included in the goggle capable to send information about safety of ski condition and information about safety of the skier, in view of the equipment equipped by the skier, a visor mounted on a surface of the goggle, wherein the visor serves as an on-demand monitor where information is displayable to the skier, and is configured to detect visibility by sensing amount of snow covering the visor; a wiper adapted to wipe away snow covering the visor.

An electronic map may be included in the goggle that displays ski trail information with respect to current location of the skier; an accelerometer included in the goggle that detects whether the skier is rolling down a slope dangerously, based on amount of rolling of the goggle given a fixed amount of time; a location detector included in the goggle that detects the current location of the skier, detects speed of the skier, detects acceleration of the skier, detects inclination of slope on which the skier is skiing; a processor; and a memory storing instructions that cause the processor to execute a method, the method comprising initiating the skiing safety system; monitoring a change of skiing conditions; when a dangerous skiing condition is found, providing alternatives to the skier in light of the dangerous skiing condition; sharing the dangerous skiing condition in real-time to other members; and reporting the dangerous skiing condition to a central system for immediate assistance.

### BRIEF DESCRIPTION OF THE DRAWINGS

FIG. 1 illustrates an exemplary system for ensuring safety of a skier.

### DETAILED DESCRIPTION

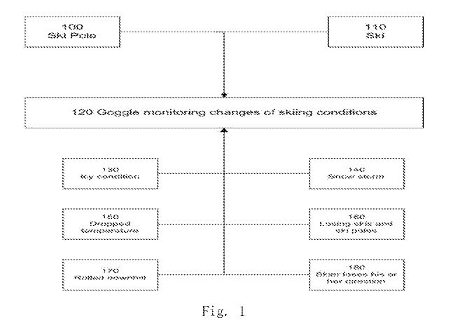

Systems and methods are provided to ensure safety of a skier. Referring to FIG. 1, embodiments of the inventions may include a skiing safety system for ensuring safety of a skier, comprising a ski pole (100), wherein the pole is associated with a type that belongs to a cross country ski pole or a alpine ski pole; a rf antenna coupled to the ski pole (100), identifying the type of the ski pole (100); a ski, wherein the pole is associated with a type that belongs to a cross country ski or a alpine ski; a rf antenna coupled to the ski, identifying the type of the ski; a speed detecting device included in the ski (110) to detect a speed and an acceleration of the ski; an accelerometer device included in the ski (110) configured to detect inclination of slope where the skier is skiing, and detect any icy conditions of current location, based on orientation detected by the accelerometer and the speed and acceleration detected by the speed detecting device; a piece of clothing, wherein the clothing is associated with a material associating with a temperature, the temperature representing a lowest temperature endured by the skier wearing the clothing; a rf antenna coupled to the clothing, identifying the type of the clothing; a goggle (120) comprising a temperature processor that includes a temperature reader in the goggle (120) detects current temperature and determines if the current temperature is below the lowest temperature endured by the skier; a rf reader included in the goggle (120) synchronized with the antennas of the ski pole (100), ski, and clothing, wherein the rf reader receives information from the ski pole (100), ski, and clothing; a rf antenna included in the goggle (120) capable to send information about safety of ski (110) condition and information about safety of the skier, in view of the equipment equipped by the skier; a visor mounted on a surface of the goggle, wherein the visor serves as an on-demand monitor where information is displayable to the skier, and is configured to detect visibility by sensing amount of snow covering the visor; a wiper adapted to wipe away snow covering the visor; an electronic map included in the goggle (120) that displays ski trail information with respect to current location of the skier; an accelerometer included in the goggle (120) that detects whether the skier is rolling down a slope dangerously, based on amount of rolling of the goggle (120) given a fixed amount of time; a location detector included in the goggle (120) that detects the current location of the skier, detects speed of the skier, detects acceleration of the skier, detects inclination of slope on which the skier is skiing; a processor; and a memory storing instructions that cause the processor to execute a method, the method comprising initiating the skiing safety system; monitoring a change of skiing conditions; when a dangerous skiing condition is found, providing alternatives to the skier in light of the dangerous skiing condition; sharing the dangerous skiing condition in real-time to other members; and reporting the dangerous skiing condition to a central system for immediate assistance.

Other aspects of the exemplary system may include a ski pole, wherein the pole is associated with a type that belongs to a cross country ski pole or a alpine ski pole; a rf antenna coupled to the ski pole, identifying the type of the ski pole; a ski, wherein the pole is associated with a type that belongs to a cross country ski or a alpine ski; a rf antenna coupled to the ski, identifying the type of the ski; a speed detecting device included in the ski to detect a speed and an acceleration of the ski; an accelerometer device included in the ski configured to detect inclination of slope where the skier is skiing, and detect any icy conditions of current location, based on orientation detected by the accelerometer and the speed and acceleration detected by the speed detecting device; a piece of clothing, wherein the clothing is associated with a material associating with a temperature, the temperature representing a lowest temperature endured by the skier wearing the clothing; a rf antenna coupled to the clothing, identifying the type of the clothing; a goggle (120) comprising a temperature processor that includes a temperature reader in the goggle (120) detects current temperature and determines if the current temperature is below the lowest temperature endured by the skier; a rf reader included in the goggle (120) synchronized with the antennas of the ski pole, ski, and clothing, wherein the rf reader receives information from the ski pole, ski, and clothing; a rf antenna included in the goggle (120) capable to send information about safety of ski condition and information about safety of the skier, in view of the equipment equipped by the skier; a visor mounted on a surface of the goggle, wherein the visor serves as an on-demand monitor where information is displayable to the skier, and is configured to detect visibility by sensing amount of snow covering the visor; a wiper adapted to wipe away snow covering the visor; an electronic map included in the goggle (120) that displays ski trail information with respect to current location of the skier; an accelerometer included in the goggle (120) that detects whether the skier is rolling down a slope dangerously, based on amount of rolling of the goggle (120) given a fixed amount of time; a location detector included in the goggle (120) that detects the current location of the skier, detects speed of the skier, detects acceleration of the skier, detects inclination of slope on which the skier is skiing; a processor; and a memory storing instructions that cause the processor to execute a method, the method comprising initiating the skiing safety system, wherein the initiation includes synchronization of the ski pole, ski, clothing, and goggle; monitoring a change of skiing conditions, wherein the conditions include: an icy condition of the current location; a snow storm affecting visibility has occurred; that when the current temperature drops to a very low temperature; that when the skier loses ski pole and ski, and stranded in the current location for an extended period of time; that when the skier loses control and rolling down at a dangerous slope; and that when the skier is lost at the current location; when a dangerous skiing condition is found, providing alternatives to the skier in light of the dangerous skiing condition; sharing the dangerous skiing condition in real-time to other members; and reporting the dangerous skiing condition to a central system for immediate assistance.

In accordance with an example, an accelerometer device may be included in the ski configured to detect inclination of slope where the skier is skiing, and detect any icy conditions of current location, based on orientation detected by the accelerometer and the speed and acceleration detected by the speed detecting device; a piece of clothing, wherein the clothing is associated with a material associating with a temperature, the temperature representing a lowest temperature endured by the skier wearing the clothing; a rf antenna coupled to the clothing, identifying the type of the clothing; a goggle (120) comprising a temperature processor that includes a temperature reader in the goggle (120) detects current temperature and determines if the current temperature is below the lowest temperature endured by the skier; a rf reader included in the goggle (120) synchronized with the antennas of the ski pole, ski, and clothing, wherein the rf reader receives information from the ski pole, ski, and clothing; a rf antenna included in the goggle (120) capable to send information about safety of ski condition and information about safety of the skier, in view of the equipment equipped by the skier; a visor mounted on a surface of the goggle, wherein the visor serves as an on-demand monitor where information is displayable to the skier, and is configured to detect visibility by sensing amount of snow covering the visor; a wiper adapted to wipe away snow covering the visor; an electronic map included in the goggle (120) that displays ski trail information with respect to current location of the skier; an accelerometer included in the goggle (120) that detects whether the skier is rolling down a slope dangerously, based on amount of rolling of the goggle (120) given a fixed amount of time; a location detector included in the goggle (120) that detects the current location of the skier, detects speed of the skier, detects acceleration of the skier, detects inclination of slope on which the skier is skiing; a processor; and a memory storing instructions that cause the processor to execute a method, the method comprising initiating the skiing safety system, wherein the initiation includes synchronization of the ski pole, ski, clothing, and goggle; monitoring a change of skiing conditions, wherein the conditions include an icy condition of the current location, as detected based on the orientation detected by the accelerometer and the speed and acceleration detected by the speed detecting device; a snow storm affecting visibility has occurred; that when the current temperature drops to a very low temperature; that when the skier loses ski pole and ski, and stranded in the current location for an extended period of time; that when the skier loses control and rolling down at a dangerous slope; and that when the skier is lost at the current location; when a dangerous skiing condition is found, wherein the dangerous skiing condition belongs to the icy condition: providing alternatives to the skier in light of the dangerous skiing condition, wherein one alternative includes showing an different route to the skier with the electronic map through the visor mounted on the surface of the goggle, wherein the route provides a less icy and thus safer skiing condition; sharing the dangerous skiing condition in real-time to other members; and reporting the dangerous skiing condition to a central system for immediate assistance.

One aspect of the memory includes initiating the skiing safety system, wherein the initiation includes synchronization of the ski pole, ski, clothing, and goggle; monitoring a change of skiing conditions, wherein the conditions include an icy condition of the current location; a snow storm affecting visibility has occurred, as detected based on sensing the amount of snow covering the visor; that when the current temperature drops to a very low temperature; that when the skier loses ski pole and ski, and stranded in the current location for an extended period of time; that when the skier loses control and rolling down at a dangerous slope; and that when the skier is lost at the current location; when a dangerous skiing condition is found, wherein the dangerous skiing condition belongs to a snow storm affecting the visibility of the skier providing alternatives to the skier in light of the dangerous skiing condition, wherein one alternative includes wiping the snow covering the visor away for the skier; sharing the dangerous skiing condition in real-time to other members; and reporting the dangerous skiing condition to a central system for immediate assistance.

In yet another aspect, the memory includes initiating the skiing safety system, wherein the initiation includes synchronization of the ski pole, ski, clothing, and goggle; monitoring a change of skiing conditions, wherein the conditions include an icy condition of the current location; a snow storm affecting visibility has occurred; that when the current temperature drops to a very low temperature, as detected by the temperature processor included in the goggle, in view of the temperature associated with the material of the clothing of the skier, as reported by the rf antenna of the clothing; that when the skier loses ski pole and ski, and stranded in the current location for an extended period of time; that when the skier loses control and rolling down at a dangerous slope; and that when the skier is lost at the current location; when a dangerous skiing condition is found, wherein the dangerous skiing condition belongs to a condition where the temperature has dropped to a very low temperature: providing alternatives to the skier in light of the dangerous skiing condition; sharing the dangerous skiing condition in real-time to other members; and reporting the dangerous skiing condition to a central system for immediate assistance.

According to another aspect, initiating the skiing safety system, wherein the initiation includes synchronization of the ski pole, ski, clothing, and goggle; monitoring a change of skiing conditions, wherein the conditions include an icy condition of the current location; a snow storm affecting visibility has occurred; that when the current temperature drops to a very low temperature; that when the skier loses ski pole and ski, and stranded in the current location for an extended period of time, as detected by the rf reader of the goggle, in that signals reported from the rf antennas of the ski pole and ski become increasingly weakening over time; that when the skier loses control and rolling down at a dangerous slope; and that when the skier is lost at the current location; when a dangerous skiing condition is found, wherein the dangerous skiing condition belongs to the condition where the skier loses the ski pole and ski; providing alternatives to the skier in light of the dangerous skiing condition; sharing the dangerous skiing condition in real-time to other members; and reporting the dangerous skiing condition to a central system for immediate assistance.

In yet another disclosure, the system includes initiating the skiing safety system, wherein the initiation includes synchronization of the ski pole, ski, clothing, and goggle; monitoring a change of skiing conditions, wherein the conditions include an icy condition of the current location; a snow storm affecting visibility has occurred; that when the current temperature drops to a very low temperature; that when the skier loses ski pole and ski, and stranded in the current location for an extended period of time; that when the skier loses control and rolling down at a dangerous slope, as detected by the accelerometer included in the goggle (120) and by the location detector included in the goggle (120) that detects the current location of the skier, speed of the skier, acceleration of the skier, and the inclination of slope on which the skier is skiing; and that when the skier is lost at the current location; when a dangerous skiing condition is found, wherein the dangerous skiing condition belongs to the condition where the skier loses control and rolling down at a dangerous slope; providing alternatives to the skier in light of the dangerous skiing condition; sharing the dangerous skiing condition in real-time to other members; and reporting the dangerous skiing condition to a central system for immediate assistance.

While the invention has been shown and described with reference to particular embodiments thereof, it will be understood by those skilled in the art that the invention can be practiced, with modification, in other environments. For example, although the invention described above can be conveniently implemented in a general purpose computer selectively reconfigured or activated by software, those skilled in the art would recognize that the invention could be carried out in hardware, in firmware or in any combination of software, firmware or hardware including a special purpose apparatus specifically designed to perform the described invention. Therefore, changes in form and detail may be made therein without departing from the spirit and scope of the invention as set forth in the accompanying claims.

What is claimed is:

1. A skiing safety system for ensuring safety of a skier, comprising:
a ski pole, wherein the pole is associated with a type that belongs to a cross country ski pole or a alpine ski pole;
a rf antenna coupled to the ski pole, identifying the type of the ski pole;
a ski, wherein the pole is associated with a type that belongs to a cross country ski or a alpine ski;
a rf antenna coupled to the ski, identifying the type of the ski;
a speed detecting device included in the ski to detect a speed and an acceleration of the ski;
an accelerometer device included in the ski configured to detect inclination of slope where the skier is skiing, and detect any icy conditions of current location, based on orientation detected by the accelerometer and the speed and acceleration detected by the speed detecting device;
a piece of clothing, wherein the clothing is associated with a material associating with a temperature, the temperature representing a lowest temperature endured by the skier wearing the clothing;
a rf antenna coupled to the clothing, identifying the type of the clothing;
a goggle comprising:
a temperature processor that includes a temperature reader in the goggle detects current temperature and determines if the current temperature is below the lowest temperature endured by the skier;
a rf reader included in the goggle synchronized with the antennas of the ski pole, ski, and clothing, wherein the rf reader receives information from the ski pole, ski, and clothing;
a rf antenna included in the goggle capable to send information about safety of ski condition and information about safety of the skier, in view of the equipment equipped by the skier;
a visor mounted on a surface of the goggle, wherein the visor serves as an on-demand monitor where information is displayable to the skier, and is configured to detect visibility by sensing amount of snow covering the visor;
a wiper adapted to wipe away snow covering the visor;
an electronic map included in the goggle that displays ski trail information with respect to current location of the skier;
an accelerometer included in the goggle that detects whether the skier is rolling down a slope dangerously, based on amount of rolling of the goggle given a fixed amount of time;
a location detector included in the goggle that detects the current location of the skier, detects speed of the skier, detects acceleration of the skier, detects inclination of slope on which the skier is skiing;
a processor, and
a memory storing instructions that cause the processor to execute a method, the method comprising:
initiating the skiing safety system;
monitoring a change of skiing conditions;
when a dangerous skiing condition is found,
providing alternatives to the skier in light of the dangerous skiing condition;
sharing the dangerous skiing condition in real-time to other members; and
reporting the dangerous skiing condition to a central system for immediate assistance.

1. The system of claim 1, wherein the initiation includes:
synchronization of the ski pole, ski, clothing, and goggle; and
monitoring the change of skiing conditions, wherein the conditions include:
an icy condition of the current location;
a snow storm affecting visibility has occurred;
that when the current temperature drops to a very low temperature;
that when the skier loses ski pole and ski, and stranded in the current location for an extended period of time;
that when the skier loses control and rolling down at a dangerous slope; and
that when the skier is lost at the current location.

2. The system of claim 2, wherein:
the condition where the icy condition of the current location is detected based on the orientation detected by the accelerometer and the speed and acceleration detected by the speed detecting device;
the dangerous skiing condition being found is the icy condition; and
one alternative includes showing an different route to the skier with the electronic map through the visor mounted on the surface of the goggle, wherein the route provides a less icy and thus safer skiing condition.

3. The system of claim 3, wherein
the condition of the occurrence of the snow storm affecting visibility is detected based on sensing the amount of snow covering the visor;
the dangerous skiing condition being found is the snow storm affecting visibility;
and
one alternative includes wiping the snow covering the visor away for the skier.

4. The system of claim 3, wherein:
the condition that the current temperature being dropped to a very low temperature is detected by the temperature processor included in the goggle, in view of the temperature associated with the material of the clothing of the skier, as reported by the rf antenna of the clothing; and
the dangerous skiing condition being found is the condition where the temperature has dropped to the very low temperature.

5. The system of claim 1, wherein”
the condition that the skier losing ski pole and ski, and being stranded in the current location for an extended period of time is detected by the rf reader of the goggle, in that signals reported from the rf antennas of the ski pole and ski become increasingly weakening over time; and
the dangerous skiing condition being found is the condition where the skier loses the ski pole and ski.

6. The system of claim 1, wherein
the condition that the skier losing control and rolling down at a dangerous slope is detected by the accelerometer included in the goggle and by the location detector included in the goggle that detects the current location of the skier, speed of the skier, acceleration of the skier, and the inclination of slope on which the skier is skiing; and
the dangerous skiing condition being found is skier loses control and rolling down at the dangerous slope.

7. The system of claim 1, wherein
the dangerous skiing condition being found is the condition where skier is lost at the current location; and
one alternative includes showing the skier, through the visor, a route that is least dangerous in view of:
the type of the ski pole of the skier;
the type of the ski of the skier;
the sloppiness of slope where the skier is currently skiing, as reported by the accelerometer of the ski;
the current temperature and the lowest temperature endured by the skier, as detected by the temperature reader of the goggle;
the electronic map including the ski trail information with respect to current location of the skier, as detected by the location detector included in the goggle; and
the speed of the skier, the acceleration of the skier, the inclination of the slope on which the skier is skiing, as reported by the location detector.

8. A skiing safety system for ensuring safety of a skier, comprising:
a ski pole, wherein the pole is associated with a type that belongs to a cross country ski pole or a alpine ski pole;
a rf antenna coupled to the ski pole, identifying the type of the ski pole;
a ski, wherein the pole is associated with a type that belongs to a cross country ski or a alpine ski;
a rf antenna coupled to the ski, identifying the type of the ski;
a speed detecting device included in the ski to detect a speed and an acceleration of the ski;
an accelerometer device included in the ski configured to detect inclination of slope where the skier is skiing, and detect any icy conditions of current location, based on orientation detected by the accelerometer and the speed and acceleration detected by the speed detecting device;
a piece of clothing, wherein the clothing is associated with a material associating with a temperature, the temperature representing a lowest temperature endured by the skier wearing the clothing;
a rf antenna coupled to the clothing, identifying the type of the clothing;
a goggle comprising:
a temperature processor that includes a temperature reader in the goggle detects current temperature and determines if the current temperature is below the lowest temperature endured by the skier;
a rf reader included in the goggle synchronized with the antennas of the ski pole, ski, and clothing, wherein the rf reader receives information from the ski pole, ski, and clothing;
a rf antenna included in the goggle capable to send information about safety of ski condition and information about safety of the skier, in view of the equipment equipped by the skier;
a visor mounted on a surface of the goggle, wherein the visor serves as an on-demand monitor where information is displayable to the skier, and is configured to detect visibility by sensing amount of snow covering the visor;
a wiper adapted to wipe away snow covering the visor;
an electronic map included in the goggle that displays ski trail information with respect to current location of the skier;
an accelerometer included in the goggle that detects whether the skier is rolling down a slope dangerously, based on amount of rolling of the goggle given a fixed amount of time;
a location detector included in the goggle that detects the current location of the skier, detects speed of the skier, detects acceleration of the skier, detects inclination of slope on which the skier is skiing;
a processor; and
a memory storing instructions that cause the processor to execute a method, the method comprising:
initiating the skiing safety system, wherein the initiation includes synchronization of the ski pole, ski, clothing, and goggle;
monitoring a change of skiing conditions, wherein the conditions include:
an icy condition of the current location, as detected based on the orientation detected by the accelerometer and the speed and acceleration detected by the speed detecting device;
a snow storm affecting visibility has occurred, as detected based on sensing the amount of snow covering the visor;
that when the current temperature drops to a very low temperature, as detected by the temperature processor included in the goggle, in view of the temperature associated with the material of the clothing of the skier, as reported by the rf antenna of the clothing;
that when the skier loses ski pole and ski, and stranded in the current location for an extended period of time, as detected by the rf reader of the goggle, in that signals reported from the rf antennas of the ski pole and ski become increasingly weakening over time;
that when the skier loses control and rolling down at a dangerous slope, as detected by the accelerometer included in the goggle and by the location detector included in the goggle that detects the current location of the skier, speed of the skier, acceleration of the skier, and the inclination of slope on which the skier is skiing; and
that when the skier is lost at the current location;
when dangerous skiing conditions are found, wherein the dangerous skiing conditions include the icy condition, a snow storm affecting the visibility of the skier, the condition where the temperature has dropped to a very low temperature, the condition where the skier loses the ski pole and ski, the condition where the skier loses control and rolling down at a dangerous slope:
providing alternatives to the skier in light of the dangerous skiing condition, wherein one alternative includes:
showing an different route to the skier with the electronic map through the visor mounted on the surface of the goggle, wherein the route provides a less icy and thus safer skiing condition;
wiping the snow covering the visor away for the skier;
showing the skier, through the visor, a route that is least dangerous in view of:
the type of the ski pole of the skier;
the type of the ski of the skier;
the sloppiness of slope where the skier is currently skiing, as reported by the accelerometer of the ski;
the current temperature and the lowest temperature endured by the skier, as detected by the temperature reader of the goggle;
the electronic map including the ski trail information with respect to current location of the skier, as detected by the location detector included in the goggle; and
the speed of the skier, the acceleration of the skier, the inclination of the slope on which the skier is skiing, as reported by the location detector;
sharing the dangerous skiing condition in real-time to other members; and
reporting the dangerous skiing condition to a central system for immediate assistance.
